(19) United States
(12) Patent Application Publication
(10) Pub. No.: US 2026/0193942 A1
(43) Pub. Date: Jul. 9, 2026

(54) WELL PIPE HANDLING

(71) Applicant: MHWIRTH AS, KRISTIANSAND S (NO)

(72) Inventors: RANGA WIJESEKARA, KRISTIANSAND S (NO); TOR MARTIN HEGGLAND, KRISTIANSAND S (NO); TOMMY BJOERKLUND, GRIMSTAD (NO); TRINE KREY LODE, KRISTIANSAND S (NO)

(73) Assignee: MHWIRTH AS, KRISTIANSAND S (NO)

(21) Appl. No.: 19/133,234

(22) PCT Filed: Nov. 14, 2023
(86) PCT No.: PCT/NO2023/060090

§ 371 Date: May 28, 2025

(30) Foreign Application Priority Data
Dec. 1, 2022 (NO) 20221287

(51) Int. Cl. E21B 17/00; B08B 9/02

(52) U.S. Cl. CPC E21B 17/006; B08B 9/021

(57) ABSTRACT

A pipe doper unit (15) comprising a receiver body (11), the receiver body (11) defining a volume (17) configured to receive an end section (50a) of a pipe (50) therein, and wherein the receiver body (11) comprises a plurality of nozzles (16a-d), the nozzles (16a-d) arranged in spaced sets of nozzles (16a-d) and directed inwardly towards the volume (17).

### CROSS REFERENCE TO PRIOR APPLICATIONS

This application is a U.S. National Phase application under 35 U.S.C. § 371 of International Application No. PCT/NO2023/060090, filed on Nov. 14, 2023 and which claims benefit to Norwegian patent application No. 20221287, filed on Dec. 1, 2022. The International Application was published in English on Jun. 6, 2024 as WO 2024/117913 A1 under PCT Article 21(2).

### FIELD

The present invention relates to technology for handling pipes used in wellbores, in particular to pipe doper units for washing and/or applying dope onto pipes used in subterranean wellbore operations before or after deployment in the well.

### BACKGROUND

In drilling operations, it is common to build a string of tubulars, such as a drill string, on a drill floor above a well center opening. The string is usually assembled using a series of threaded pipe sections, where the threaded connections are made up (or broken out) using appropriate machines, such as pipe handling machines and power tongs. The process of assembling or disassembling the string can be repeated a number of times during the construction of a wellbore. Other operations, such as well intervention operations, may also be carried out using the same principles.

The integrity of the connections in the string is of high importance, particularly considering the loads the string may be exposed to during use and the fact that the same pipe sections may be subjected to make up (connect) and break out (disconnect) operations numerous times during its lifetime. For this purpose, lubricating and surface protecting material, commonly known as dope, is usually applied on the pipe section threads before connection.

Publications which may be useful to understand the field of technology of the present invention include WO 2002/08564 A1, U.S. Pat. No. 4,014,062 A, NO 173893 B, WO 1999/60245 A1, WO 2012/115523 A1, and NO 344708 B1.

### SUMMARY

An aspect of the present invention is to further improve the reliability, operational lifetime, and operational efficiency of wellbore equipment and of machines used on drilling rigs. A further aspect of the present invention is to provide improved systems and methods in the above-mentioned or other areas, or to at least provide useful alternatives to the state of the art.

In an embodiment, the present invention provides a pipe doper unit which includes a receiver body which defines a volume which is configured to receive an end section of a pipe therein. The receiver body comprises a plurality of nozzles. The plurality of nozzles are arranged as a spaced sets of nozzles which are directed inwardly towards the volume.

### BRIEF DESCRIPTION OF THE DRAWINGS

The present invention is described in greater detail below on the basis of embodiments and of the drawings in which:

FIG. 1 shows a pipe handling machine having a pipe doper unit arranged at a base thereof;

FIG. 2 shows upper and lower pipe handling machines for handling vertical pipes on a drilling rig;

FIG. 3 shows a pipe doper unit according to an embodiment of the present invention;

FIG. 4 shows details of the pipe doper unit of FIG. 3 along with various optional features thereof where the receiver body is used to clean an end section of a pipe when a pipe end section is lowered into the volume, i.e., the second configuration;

FIG. 5 shows details of the pipe doper unit of FIG. 3 along with various optional features thereof where the receiver body is used to clean an end section of a pipe when a pipe end section is positioned in the volume and is moved upwardly, out of the volume, i.e., the first configuration;

FIG. 6 shows details of the pipe doper unit of FIG. 3 along with various optional features thereof, in particular, where the receiver body, which comprises a front opening, is moveable between a first operational configuration in which the first opening is oriented upwardly, and a second operational configuration in which the second opening is oriented upwardly;

FIG. 7 shows details of the pipe doper unit of FIG. 3 along with various optional features thereof, in particular, where the receiver body, which comprises a front opening, is moveable between a first operational configuration in which the first opening is oriented upwardly, and a second operational configuration in which the second opening is oriented upwardly;

FIG. 8 shows details of the pipe doper unit of FIG. 3 along with various optional features thereof, in particular, where the receiver body is moveable between a first operational configuration in which the first opening is oriented upwardly, and a second operational configuration in which the second opening is oriented upwardly;

FIG. 9 shows details of the pipe doper unit of FIG. 3 along with various optional features thereof, in particular, that the door(s) may be arranged to have a fixed, fully open position, as indicated in dashed lines, in the event that closing of the opening is not required;

FIG. 10 shows details of the pipe doper unit of FIG. 3 along with various optional features thereof, in particular, that a collection tray can be couplable to the base or to the receiver body so as to be arranged below the volume;

FIG. 11 shows details of the pipe doper unit of FIG. 3 along with various optional features thereof, in particular, that the pipe doper unit can be arranged with a base having first and second parts, where the second part is configured for fixing to an external structure;

FIG. 12 shows details of the pipe doper unit of FIG. 3 along with various optional features thereof, in particular, that the pipe doper unit may comprise a pipe detection sensor which is operable to identify the end section of the pipe at or adjacent to the second opening; and

FIG. 13 shows details of the pipe doper unit of FIG. 3 along with various optional features thereof, in particular, that the pipe doper unit may comprise a pipe detection sensor which is operable to identify the end section of the pipe at or adjacent to the second opening.

### DETAILED DESCRIPTION

The present invention provides a pipe doper unit comprising a receiver body, the receiver body defining a volume which is configured to receive an end section of a pipe therein, wherein the receiver body comprises a plurality of nozzles, the nozzles being arranged in spaced sets of nozzles and being directed inwardly towards the volume.

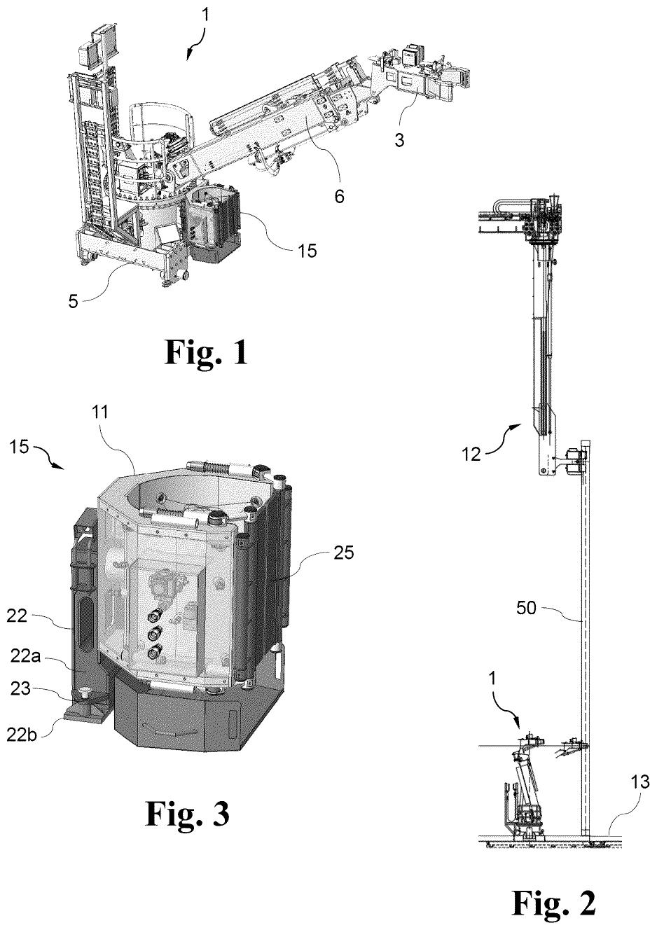

FIG. 1 shows a pipe handling machine, in this example a lower pipe handling machine 1, which is suitable for use on, for example, drilling rigs. The lower pipe handling machine 1 comprises a machine base 5 on which an arm 6 is mounted. The arm 6 comprises a guide head 3 to support a pipe 50, for example, a section of drill string (a so-called stand) from a pipe storage. The pipe storage may include a setback and a fingerboard defining storage spaces/slots in which the drill string stands or where other tubular members (such as sections of casing string) may be stored. The lower pipe handling machine 1 cooperates with an upper pipe handling machine 12 (see FIG. 2) to hold and move the pipe 50 while the pipe is in a vertical orientation. The lower pipe handling machine 1 may be arranged to be movable on a drill floor 13, for example, on tracks or rails, while the upper pipe handling machine 12 may be movable on or along a superstructure above the drill floor 13. The lower and upper pipe handling machines 1, 12 cooperate to move pipes 50 between a well center area and a pipe storage. The skilled reader will recognize this basic setup as a conventional pipe handling arrangement on drilling rigs. Other arrangements for handling pipes are also available and may be used together with the systems and methods according to the present invention.

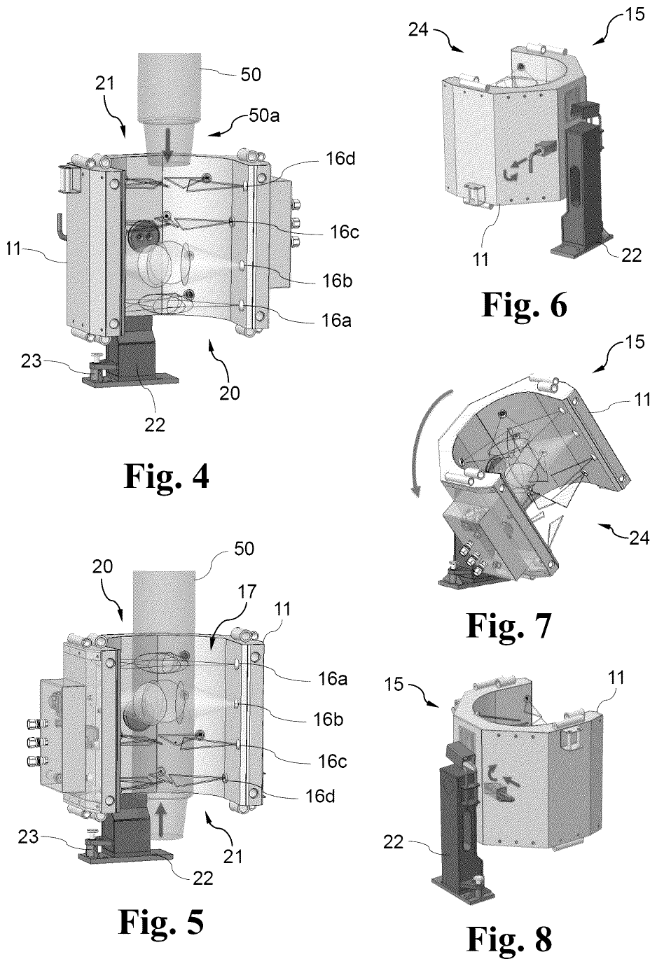

FIG. 3 shows a pipe doper unit 15. FIGS. 4-13 illustrate details of the pipe doper unit shown in FIG. 3 along with various optional features thereof. The pipe doper unit 15 comprises a receiver body 11 which defines a volume 17 (see FIG. 5) which is configured to receive an end section of the pipe 50 therein via one or more openings in the receiver body 11. The receiver body 11 may, for example, be an elongate housing structure which is configured to receive an end section 50a (see FIGS. 4 and 5) of a pipe 50 therein. The pipe 50 may be a section of drill string, a section of casing pipe, or other types of pipe used in well operations.

In this embodiment, the pipe 50 is a section of drill string. When drilling subterranean wellbores, the drill string may be constructed and disassembled several times, with pipe sections being stored in a pipe storage, as described above. When constructing a drill string from pipe sections, threads interconnecting two pipe sections are usually cleaned and provided with dope before making up the threaded connection. The dope can provide lubrication and reduce wear on the threads. Similarly, when retrieving a drill string and disassembling the drill string, the broken-out threads may be cleaned and dope provided onto the threads before the pipe section is brought to the pipe storage.

According to the present invention, such cleaning and doping can be carried out by a pipe doper unit 15. For this purpose, the receiver body 11 comprises a plurality of nozzles 16a-d (see FIG. 5) which are arranged as vertically spaced sets of nozzles and directed inwardly towards the volume 17. An end section 50a, for example, comprising the pin end of a pin-and-box threaded connection, of a pipe 50 can be moved into the volume 17, and the nozzles 16a-d may provide cleaning and application of dope onto the end section 50a.

In the shown embodiment, the nozzles 16a-d include cleaning nozzles 16c, 16d (for example, for applying water or another cleaning liquid), drying nozzles 16b (for example, for applying air for drying) and doping nozzles 16a (for applying dope). Each of these sets comprises a plurality of nozzles distributed (for example, arranged circumferentially) about the volume 17, and thereby about the pipe 50 when the pipe 50 is positioned in the volume 17. Each set may, for example, comprise four or more individual nozzles. The sets of nozzles 16a-d are spaced, for example, spaced vertically (when in the orientation of the receiver body 11 as shown in FIGS. 3-5, which are the operational orientations).

For receiving the end section 50a, the receiver body 11 comprises a first opening 20 and a second opening 21 (see FIGS. 4 and 5). In this embodiment, the first and second openings 20, 21 are arranged opposite to each other at different ends of the receiver body 11 so that the first and second openings 20, 21 and the volume 17 together make up a substantially straight, through-going channel through the receiver body 11. Other arrangements may, however, be possible.

In the drawings, spray cones from the nozzles 16a-d are schematically illustrated in order to illustrate their function, however, the skilled reader will understand that the nozzles 16a-d may be operated sequentially.

FIG. 4 shows a situation where the pipe 50 is moved from the well center after being retrieved from the well. The pipe end section 50a is positioned above the second opening 21 and subsequently lowered into the volume 17. The nozzles 16a-d are operated sequentially during this motion. The cleaning nozzles 16c, 16d are first activated to clean the end section 50a, and in particular the threads on the end section 50a. The drying nozzles 16b are thereafter activated to dry the end section 50a. Finally, the doping nozzles 16a are activated to apply dope on the end section 50a. The pipe 50 can subsequently be moved to the pipe storage.

The pipe doper unit 15 may be arranged on a pipe handling machine, for example, on the base 5 of the pipe handling machine 1, as shown in FIG. 1. The pipe doper unit 15 can alternatively be arranged on or configured to be arranged on a drill floor 13 separate from the upper and lower pipe handling machines 1, 12. A dope storage depot or supply line, water or cleaning fluid supply, compressed air or gas supply, pumps, power, or other auxiliary resources may be arranged and/or provided to the pipe doper unit 15 as required.

In an embodiment, the receiver body 11 can, for example, be moveable between a first operational configuration in which the first opening 20 is oriented upwardly, and a second operational configuration in which the second opening 21 is oriented upwardly. This is illustrated in FIGS. 6-8. FIG. 4 shows the receiver body 11 in the second configuration and FIG. 5 shows the receiver body 11 in the first configuration. The base 22 onto which the receiver body 11 is fixed may, for example, comprise a mechanism to allow for rotation of the receiver body 11. The receiver body 11 may alternatively be releasable from the base 22 and rotated separately.

The receiver body 11 can thereby be used to clean an end section 50a of a pipe 50 both when a pipe end section 50a is lowered into the volume 17, as described above and illustrated in FIG. 4, and when a pipe end section 50a is positioned in the volume 17 and moved upwardly out of the volume 17. The latter situation is illustrated in FIG. 5, wherein the pipe 50 is first positioned in the receiver body 11, then moved upwardly while the nozzles are sequentially activated. As above, the cleaning nozzles 16c, 16d can first be activated, then the dryer nozzles 16b, and finally the doping nozzles 16a. As the end section 50a leaves the volume 17, the end section 50a has been cleaned and dope has been applied thereto.

In any of the embodiments described herein, the receiver body 11 may further comprise a front opening 24 (indicated in relation to FIGS. 6 and 7). The front opening 24 can be arranged so as to allow the pipe 50 to be moved into the volume 17 horizontally (i.e., radially). This advantageously allows the pipe 50 to be moved into the volume 17 radially, into the position illustrated in FIG. 5, and to be moved out of the volume 17 longitudinally (upwardly as illustrated in FIG. 5) while being subjected to cleaning and doping. This provides a more efficient handling of the pipes in that the pipe 50 which is, for example, being moved horizontally by the upper and lower pipe handling machines 1, 12 from a pipe storage, can be moved into the receiver body 11 horizontally (radially) and then vertically (longitudinally) out of the receiver body 11, or being moved into the receiver body 11 longitudinally and out of the receiver body 11 radially.

The receiver body 11 may advantageously comprise a front opening 24 and be rotatable between first and second configurations as described above. In such an embodiment, the pipe 50 can be moved into the receiver body 11 horizontally when being moved from the pipe storage to the well center, i.e., when building a drill string. In this operation, good knowledge of the position of the lowermost end of the pipe 50 typically exists in that the pipe 50 has been picked up from a setback. The pipe 50 may thus be picked up and moved horizontally by the upper and lower pipe handling machines 1, 12 into the receiver body 11 as illustrated in FIG. 5, cleaned and doped, and then further moved to the well center area.

When moving pipes 50 from the well center area during tripping out and disassembly of the drill string, control of the lowermost end of each pipe 50 can be more challenging, as the height of the stick-up varies and each section of pipe 50 used in the drill string may have different lengths. In this operation, it may be advantageous to enter the pipe 50 vertically into the receiver body 11, as illustrated in FIG. 4, and out of the receiver body 11 horizontally, through the front opening 24.

The receiver body 11 can thereby be oriented in the configuration which is most efficient according to which operation is being performed by the drilling rig.

The pipe doper unit 15 may comprise a pipe detection sensor 27 which is operable to identify the end section 50a of the pipe 50 at or adjacent to the second opening 21. This is illustrated in FIGS. 12 and 13. The pipe detection sensor 27 may, for example, be an ultrasonic sensor, a proximity type sensor, for example, in combination with a tilt arm assembly, or another suitable type of sensor. Although the pipe detection sensor 27 is illustrated arranged at a holder above and outside the receiver body 11, the skilled reader will understand that the pipe detection sensor 27 may, for example, also be arranged integrated into the receiver body 11 for protection, or have a protective housing or guards to protect from, for example, mechanical damage.

Use of the pipe detection sensor 27 can provide an indication of when the end section 50a reaches the volume 17. This information can, for example, be provided to an operator for the purpose of initiating a controlled lowering of the pipe 50 into the receiver body 11 and/or activating the nozzles 16a-d. This provides better operational control of the pipe doper unit 15.

A controller 28 may be provided and operatively connected to the pipe detection sensor 27. The controller 28 may, for example, be used to automate movement of the pipe 50, for example, to stop the upper and lower pipe handling machines 1, 12 when the pipe 50 reaches the position as shown in FIG. 13. The controller 28 can alternatively or additionally be arranged to control the operation of the nozzles 16a-d based at least partly on a signal from the pipe detection sensor 27. The sequential operation of the nozzles 16a-d can, for example, be initiated based on a measured signal which is representative of the position of the end section 50a and a signal which is representative of the vertical position of the pipe 50 provided from the upper and lower pipe handling machines 1, 12. The pipe detection sensor 27 may alternatively be arranged to measure a change in position of the pipe 50 (for example, an updated position or a velocity of the pipe 50) and activate the nozzles 16a-d in response thereto. The pipe 50 can thereby be moved into the receiver body 11 by an operator or by an automated pipe handling system, and the operation of the nozzles 16a-d are automatically activated based on identification of the pipe 50.

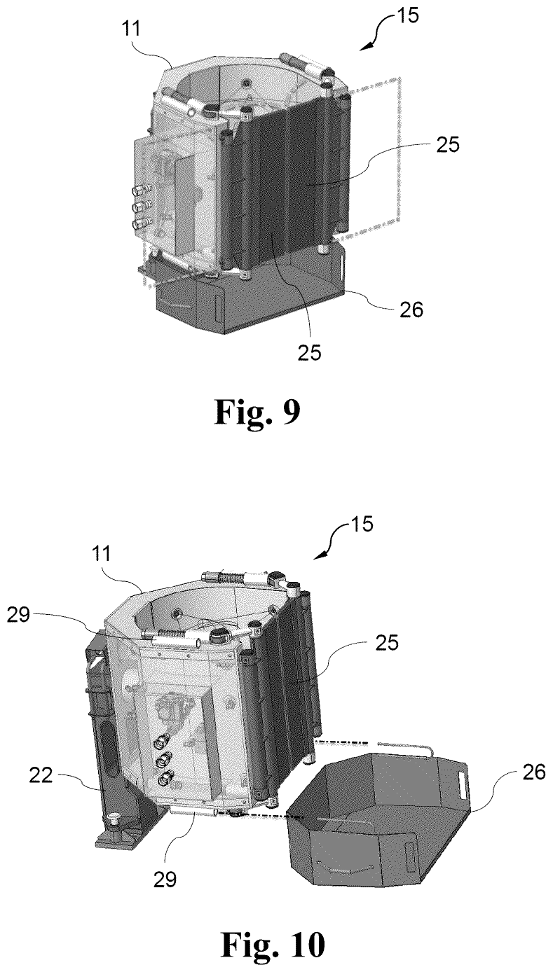

In any of the embodiments described herein, the pipe doper unit 15 may comprise at least one door 25 which is arranged at the front opening 24. The door(s) 25 may be one or more flexible members (such as rubber members) and/or a spring-loaded mechanism. The door(s) 25 can be passively controlled so that the pipe 50 can be led through the front opening 24 with the door(s) 25 being pushed aside when the pipe 50 is provided into or out of the receiver body 11. The door(s) 25 can provide protection when operating the nozzles 16a-d in order to prevent cleaning fluid and/or dope from being sprayed out of the receiver body 11. The door(s) 25 may be arranged to have a fixed, fully open position, as indicated in dashed lines in FIG. 9 if a closing of the front opening 24 is not required.

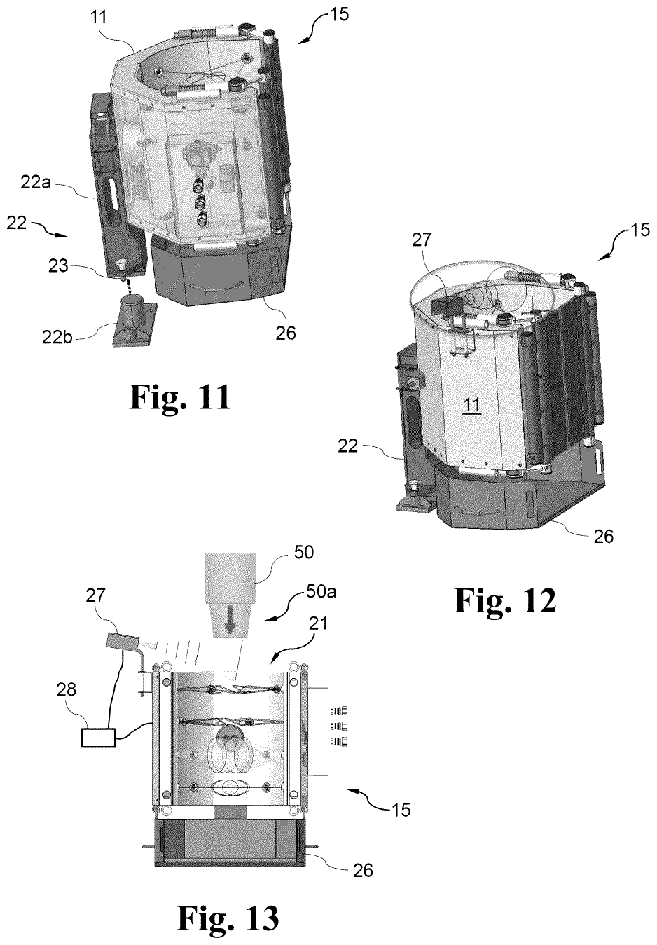

FIG. 11 shows that the pipe doper unit 15 can be arranged with a base 22 having first and second parts 22a, 22b, where the second part 22b is configured for fixing to an external structure. The external structure may, as described above, for example, be the upper pipe handling machine 1, the lower pipe handling machine 12, or a drill floor 13. The first part 22a is arranged to hold the receiver body 11.

A shear member 23, for example, a rupture pin or equivalent, can advantageously be provided between the first and second parts 22a, 22b to release the receiver body 11 from the second part 22b if a pre-determined load on the shear member 23 is exceeded. This can, for example, be the case if the pipe 50 unintentionally hits the receiver body 11. The shear member 23 can then release the receiver body 11 (in this case together with the first part 22a) from the external structure before any larger forces are imposed on the receiver body 11, which could cause damage to the receiver body 11.

FIG. 10 shows a collection tray 26 which can be couplable to the base 22 or to the receiver body 11 so as to be arranged below the volume 17. The collection tray 26 can be removably couplable to the base 22 or to the receiver body 11 in order to allow the collection tray 26 to be removed and emptied. If the collection tray 26 is coupled to the receiver body 11 and the receiver body 11 is rotatable (compare the discussion above in relation to FIGS. 6-8), the receiver body 11 may have connection members 29 arranged at both sides, i.e., both adjacent to the first opening 20 and the second opening 21, for engagement with corresponding connection members on the collection tray 26.

The present invention is not limited by the embodiments described above; reference should be had to the appended claims.

LIST OF REFERENCE NUMERALS

| | |
|---|---|
| 1 | Lower pipe handling machine |
| 2 | Guide head |
| 5 | Machine base |
| 6 | Arm |
| 11 | Receiver body |
| 12 | Upper pipe handling machine |
| 13 | Drill floor |
| 15 | Pipe doper unit |
| 16a | Nozzle/Doping nozzle |
| 16b | Nozzle/Drying nozzle |
| 16c | Nozzle/Cleaning nozzle |
| 16d | Nozzle/Cleaning nozzle |
| 17 | Volume |
| 20 | First opening |
| 21 | Second opening |
| 22 | Base |
| 22a | First part (of base) |
| 22b | Second part (of base) |
| 23 | Shear member |
| 24 | Front opening |
| 25 | Door |
| 26 | Collection tray |
| 27 | Pipe detection sensor |
| 28 | Controller |
| 29 | Connection member |
| 50 | Pipe |
| 50a | End section (of pipe) |

What is claimed is:

1-20. (canceled)

21: A pipe doper unit comprising:
a receiver body which defines a volume which is configured to receive an end section of a pipe therein, the receiver body comprising a plurality of nozzles,
wherein,
the plurality of nozzles are arranged as a spaced sets of nozzles which are directed inwardly towards the volume.

22: The pipe doper unit as recited in claim 21, wherein the receiver body further comprises a first opening which is configured so that the end section of the pipe can extend into the volume therethrough.

23: The pipe doper unit as recited in claim 22, wherein the receiver body further comprises a second opening which is configured so that the end section of the pipe can extend into the volume therethrough.

24: The pipe doper unit as recited in claim 23, wherein the first opening is arranged opposite to the second opening.

25: The pipe doper unit as recited in claim 24, wherein the first opening, the second opening, and the volume, are arranged to provide a substantially straight, through-going channel through the receiver body.

26: The pipe doper unit as recited in claim 23, wherein the receiver body is configured to be moveable between a first operational configuration in which the first opening is oriented upwardly, and a second operational configuration in which the second opening is oriented upwardly.

27: The pipe doper unit as recited in claim 26, further comprising:
a base which is configured so that the receiver body is connected thereon or is connectable thereon.

28: The pipe doper unit as recited in claim 27, wherein the base comprises a shear member which is configured to release the receiver body from a part of the base if a pre-determined load on the shear member is exceeded.

29: The pipe doper unit as recited in claim 27, wherein the receiver body is moveable between the first operational configuration and the second operational configuration while connected to the base.

30: The pipe doper unit as recited in claim 29, further comprising:
a collection tray which is configured to be couplable to the base or to the receiver body so as to be arranged below the volume.

31: The pipe doper unit as recited in claim 23, further comprising:
a pipe detection sensor which is configured to identify the end section of the pipe at or adjacent to the second opening.

32: The pipe doper unit as recited in claim 31, further comprising:
a controller which is operatively connected to the pipe detection sensor and to the plurality of nozzles which are arranged as the spaced sets of nozzles, the controller being configured to control an operation of the plurality of nozzles which are arranged as the spaced sets of nozzles based at least partly on a signal from the pipe detection sensor.

33: The pipe doper unit as recited in claim 21, wherein,
the spaced sets of nozzles comprise,
at least one set of cleaning nozzles, and
at least one set of doping nozzles, and
the at least one set of cleaning nozzles are arranged spaced from the at least one set of doping nozzles.

34: The pipe doper unit as recited in claim 33, wherein the spaced sets of nozzles further comprise at least one set of drying nozzles.

35: The pipe doper unit of claim 34, wherein the at least one set of drying nozzles is arranged spaced from each of the at least one set of cleaning nozzles and from the at least one set of doping nozzles.

36: The pipe doper unit as recited in claim 35, wherein the at least one set of drying nozzles is arranged between the at least one set of cleaning nozzles and the at least one set of doping nozzles.

37: The pipe doper unit as recited in claim 21, wherein the receiver body further comprises a front opening.

38: The pipe doper unit as recited in claim 37, wherein the front opening comprises at least one door.

39: The pipe doper unit as recited in claim 21, wherein the pipe doper unit is arranged on or is configured to be arranged on a pipe handling machine which is moveable on a drill floor.

40: The pipe doper unit as recited in claim 21, wherein the pipe doper unit is arranged on or is configured to be arranged on a drill floor separate from a pipe handling machine.
